(19) United States
(12) Patent Application Publication
(10) Pub. No.: US 2019/0066207 A1
(43) Pub. Date: Feb. 28, 2019

(54) SYSTEMS AND METHODS FOR RESOLVING CONFLICTS IN ORDER MANAGEMENT OF DATA PRODUCTS

(71) Applicant: Tata Consultancy Services Limited, Mumbai (IN)

(72) Inventors: Sandeep SAXENA, Gurgaon (IN); Vijayarangan NATARAJAN, Chennai (IN); Shirish Subhash KARANDE, Pune (IN); Kishore PADMANABHAN, Chennai (IN); Ram Harith VISWANATHAN, Chennai (IN)

(73) Assignee: Tata Consultancy Services Limited, Mumbai (IN)

(21) Appl. No.: 16/078,453

(22) PCT Filed: Feb. 22, 2017
(86) PCT No.: PCT/IB2017/050987

§ 371 Date: Aug. 21, 2018

(30) Foreign Application Priority Data
Feb. 22, 2016 (IN) 201621006135

(51) Int. Cl. G06Q 40/04; G06Q 30/06; G06F 17/30

(52) U.S. Cl. CPC G06Q 40/04; G06F 17/30563; G06Q 30/0605

(57) ABSTRACT

Conventional systems and methods for order management are not geared to address varying and modifiable attributes of data products which may lead to conflicts that need to be resolved for a trade to conclude. Systems and methods are provided for resolving such conflicts prevalent in voluminous data hubs such as data marketplaces associated with buy orders and sell orders including metadata associated with product data, terms and conditions and price attributes. The conflict resolution provided is an automated and streamlined process that takes into account basic requirements of buyers and sellers along with a comprehensive resolution of conflicts that may arise when meeting the privacy requirements associated with data being traded, contract requirements proposed or concluded for the data being traded, reputation score associated with the trading parties and price discovery based on the variations in trading mechanisms possible in huge data marketplace.

### PRIORITY CLAIM

This application is a U.S. National Stage Filing under 35 U.S.C. § 371 and claims priority from International Application No. PCT/IB2017/050987, filed on Feb. 22, 2017, which application claims priority under 35 U.S.C. § 119 from Indian Application No. 201621006135, filed on Feb. 22, 2016. The entire contents of each are incorporated herein by reference.

### TECHNICAL FIELD

The embodiments herein generally relate to conflict resolution, and more particularly to systems and methods for resolving conflicts involved in data exchange or order management of data products in voluminous data hubs such as data marketplaces.

### BACKGROUND

Order Management and Provisioning (OMP) solutions are plagued not only by business challenges but a pressing need to execute orders in the quickest possible manner through comprehensive pre-integration with downstream order consumers. Improved time-to-market through pre-integrated offer configuration and order execution, enabling time to realize revenues, reduced order fallout by ensuring pre-defined and pre-tested fulfillment processes, enabling improved cost to realize revenues, improving operational efficiencies, executed order visibility and tracking across the lifecycle, ensuring appropriate communication and Service Level Agreement (SLA) management and computed operational metrics and Key Performance Indicators (KPIs) managed effectively by continual improvement of operations and associated costs are some of the aspects that need to be addressed.

Unlike trade involving financial products or tangible commodities, order management of data products may be plagued by challenges involving conflicts that may possibly arise on account of data products being part of multiple listings and involving mutable terms and conditions. Resolving such conflicts arising in order management of data products, where particularly large volume of data products in data marketplaces are traded at a rate of more than hundred thousand orders per hour is a challenge to be addressed.

### SUMMARY

Embodiments of the present disclosure present technological improvements as solutions to one or more of the above-mentioned technical problems recognized by the inventors in conventional systems.

In an aspect, there is provided a method comprising: generating, by a Buy Order Listing module, a list of buy orders comprising a first set of buy data products associated with at least one buyer; generating, by a Sell Order Listing module, a list of sell orders comprising a second set of sell data products associated with at least one seller; wherein the buy data products and the sell data products are characterized by one or more attributes being at least one of mutable attributes and immutable attributes; identifying, by a Product Discovery module, a matching sell data product corresponding to one or more of the buy data products based on metadata of data items associated thereof; in response to the matching sell data product, resolving conflicts, by the Product Discovery module, between the buy data products and the matching sell data products based on the one or more attributes, to generate a set of inflight orders corresponding to the one or more buy data products; and processing, by an Order Processing module, the set of inflight orders corresponding to the one or more buy data products based on price negotiation to generate a set of concluded sale orders.

In another aspect, there is provided a system comprising: one or more processors; and one or more internal data storage devices operatively coupled to the one or more processors for storing instructions configured for execution by the one or more processors, the instructions being comprised in: a Buy Order Listing module configured to generate a list of buy orders comprising a first set of buy data products associated with at least one buyer; a Sell Order Listing module configured to generate a list of sell orders comprising a second set of sell data products associated with at least one seller; a Product Discovery module configured to: identify a matching sell data product corresponding to one or more of the buy data products based on metadata of data items associated thereof; and in response to the matching sell data product, resolve conflicts between the buy data products and the matching sell data products based on the one or more attributes, to generate a set of inflight orders corresponding to the one or more buy data products; an Order Processing module configured to process the set of inflight orders corresponding to the one or more buy data products based on price negotiation to generate a set of concluded sale orders; and a Repository of Concluded Sale Orders configured to store the set of concluded sale orders.

In an embodiment, the system of the present disclosure may further comprise an Order Execution module configured to execute the set of concluded sale orders by generating an access key for the at least one buyer to access a corresponding concluded sale order from the set of concluded sale orders.

In yet another aspect, there is provided a computer program product comprising a non-transitory computer readable medium having a computer readable program embodied therein, wherein the computer readable program, when executed on a computing device, causes generate a list of buy orders comprising a first set of buy data products associated with at least one buyer; generate a list of sell orders comprising a second set of sell data products associated with at least one seller; wherein the buy data products and the sell data products are characterized by one or more attributes being at least one of mutable attributes and immutable attributes; identify a matching sell data product corresponding to one or more of the buy data products based on metadata of data items associated thereof; in response to the matching sell data product, resolve conflicts between the buy data products and the matching sell data products based on the one or more attributes, to generate a set of inflight orders corresponding to the one or more buy data products; and process the set of inflight orders corresponding to the one or more buy data products based on price negotiation to generate a set of concluded sale orders.

In an embodiment of the present disclosure, the one or more attributes comprise (a) non-financial attributes comprising the metadata associated with the data items, reputation scores of the associated sellers or buyers, contract terms and privacy requirements; and (b) financial attributes comprising price associated thereof.

In an embodiment of the present disclosure, the Buy Order Listing module and the Sell Order Listing module are further configured to generate the list of buy orders and the list of sell order respectively by: receiving the one or more attributes associated with the buy data products or the sell data products, wherein at least some of the one or more attributes are in a templatized form; validating the received one or more attributes for form and conformance with at least the immutable attributes associated with a corresponding previously concluded sale order; and publishing the validated buy data products and the sell data products in the list of buy orders and the list of sell orders respectively.

In an embodiment of the present disclosure, the matching sell data product corresponding to the one or more buy data products is either one sell data product from the second set or a child sell data product created in the second set by bundling a plurality of sell data products, being parent sell data products from the second set, wherein the child sell data product inherits at least the immutable attributes associated with the parent sell data products.

In an embodiment of the present disclosure, the Product Discovery module is further configured to resolving conflicts by: checking conformance of the non-financial attributes associated with the matching sell data product with at least one of (a) the non-financial attributes associated with a corresponding buy data product; and (b) a corresponding previously concluded sale order matching the corresponding buy data product in the Repository of Concluded Sale Orders; selectively identifying the matching sell data product as an inflight order based on ranks associated with at least one of the corresponding buyer and seller; and modifying at least some of the mutable attributes associated with at least one of the buy data product and the corresponding matching sell data product.

In an embodiment of the present disclosure, the Order Processing module is further configured to process the set of inflight orders by: modifying price associated with at least one of the buy data product and the corresponding inflight order; and concluding on the associated financial attributes by a price discovery mechanism to generate the set of concluded sale orders.

In an embodiment of the present disclosure, the Order Execution module is further configured to: check conformance of the non-financial attributes associated with the set of concluded sale orders with the corresponding previously concluded sale order in the Repository of Concluded Sale Orders; generate the access key after financial settlement of the set of concluded sale orders; update the Repository of Concluded Sale Orders with the set of concluded sale orders; and update the set of inflight orders based on the set of concluded sale orders based on contention processing or resolution.

### BRIEF DESCRIPTION OF THE DRAWINGS

The embodiments herein will be better understood from the following detailed description with reference to the drawings, in which:

FIG. 1 illustrates an exemplary block diagram of a system for resolving conflicts in order management of data products, in accordance with an embodiment of the present disclosure;

FIG. 2 is an exemplary representation of functional modules comprising the system of FIG. 1, in accordance with an embodiment of the present disclosure;

FIG. 3A and FIG. 3B illustrate a computer implemented method for resolving conflicts in order management of data products, in accordance with an embodiment of the present disclosure;

FIG. 4 illustrates a flow diagram of an exemplary process for generating a buy data product or sell data product in accordance with an embodiment of the present disclosure;

FIG. 5 illustrates a flow diagram of an exemplary process when a buyer places an order for a sell data product in accordance with an embodiment of the present disclosure; and

FIG. 6 illustrates a flow diagram of an exemplary process when a seller places an order for a buy data product in accordance with an embodiment of the present disclosure.

It should be appreciated by those skilled in the art that any block diagram herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computing device or processor, whether or not such computing device or processor is explicitly shown.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Some embodiments of this disclosure, illustrating all its features, will now be discussed in detail. The disclosed embodiments are merely exemplary of the disclosure, which may be embodied in various forms. Before setting forth the detailed explanation, it is noted that all of the discussion below, regardless of the particular implementation being described, is exemplary in nature, rather than limiting.

Exchange or trade of data products, particularly in data hubs like data marketplace is a challenge firstly because data products are characterized by at least some mutable attributes that may be negotiated and modified during trade. Varying terms and conditions along with multiple price discovery mechanisms that may be associated with data products add to the complexity of order management involving data products. Secondly, volume of data products that may be traded in a data marketplace is huge and rate of execution of orders may be of an order greater than hundred thousand orders per hour. Data marketplaces have proliferated with the growth of big data. There is an explosion of data that can be collected, communicated, aggregated, stored or analyzed. Big data is increasingly being recognized as an asset that may be exchanged towards meaningful trade. Conventional order management systems and methods involving tangible commodities or financial products are not geared to address varying and modifiable attributes of data products which may lead to conflicts that need to be resolved for a trade to conclude. Systems and methods of the present disclosure address this challenge by considering basic requirements of buyers and sellers along with comprehensive resolution of conflicts that may arise when meeting the privacy requirements associated with data products being traded, contract requirements proposed or concluded for data products being traded, reputation scores associated with trading parties and various price discovery mechanisms possible in data marketplaces. Some of these attributes may also be governed by the laws of the land.

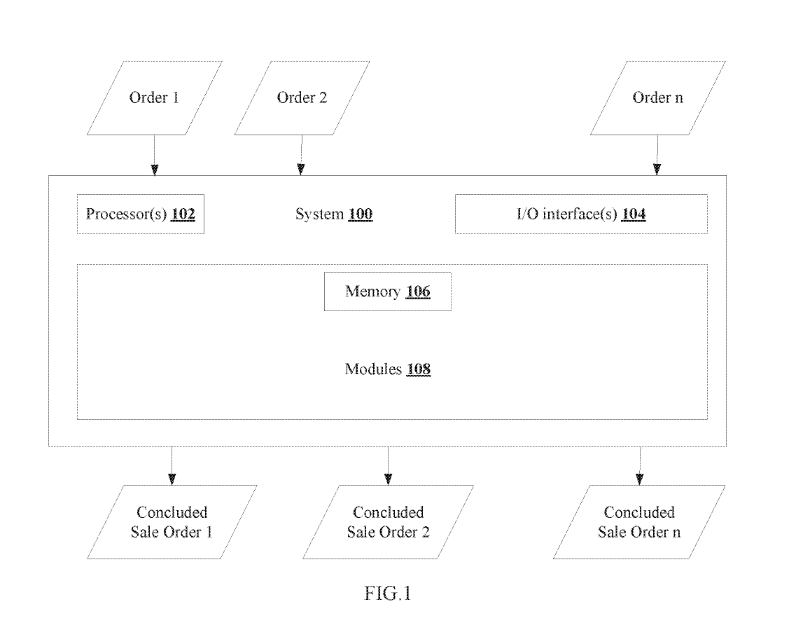

Referring now to the drawings, and more particularly to FIGS. 1 through 6, where similar reference characters denote corresponding features consistently throughout the figures, there are shown preferred embodiments and these embodiments are described in the context of the following exemplary system and method.

The expression “data product” in the context of the present disclosure refers to data pertaining to business intelligence, advertising, demographics, personal information, research and market data, and the like, that may be traded in the form of an asset on data marketplace. In accordance with the present disclosure, the data products may be characterized by one or more attributes, some of which may be mutable attributes and some immutable attributes.

The expression “buy order” and “sell order” in the context of the present disclosure refers to a request to buy or sell data product(s) respectively with possibly some modifications to one or more attributes of the data products. Accordingly, a “buy data product” may relate to a buy order created by a buyer or a sell order (having matching metadata) referenced by a buyer with possibly some modifications to one or more attributes made to the referenced sell order. Also, a “sell data product” may relate to a sell order created by a seller or a buy order (having matching metadata) referenced by a seller with possibly some modifications to one or more attributes made to the referenced buy order.

The expression “bundling” in the context of the present disclosure refers to a collection of one or more sell orders or data products comprised within the sell orders to form a child sell order.

The expression “inflight order” refers to an order where one or more attributes are being negotiated and hence order is not accepted, or an order is accepted but the processing of the order is not complete.

The expression “concluded sale order” in the context of the present disclosure refers to an order where conflicts, if any, in one or more attributes of the data products between a buy order and a sell order are resolved, negotiation of the one or more attributes is completed and the order may be executed for closing the trade between buyer(s) and seller(s).

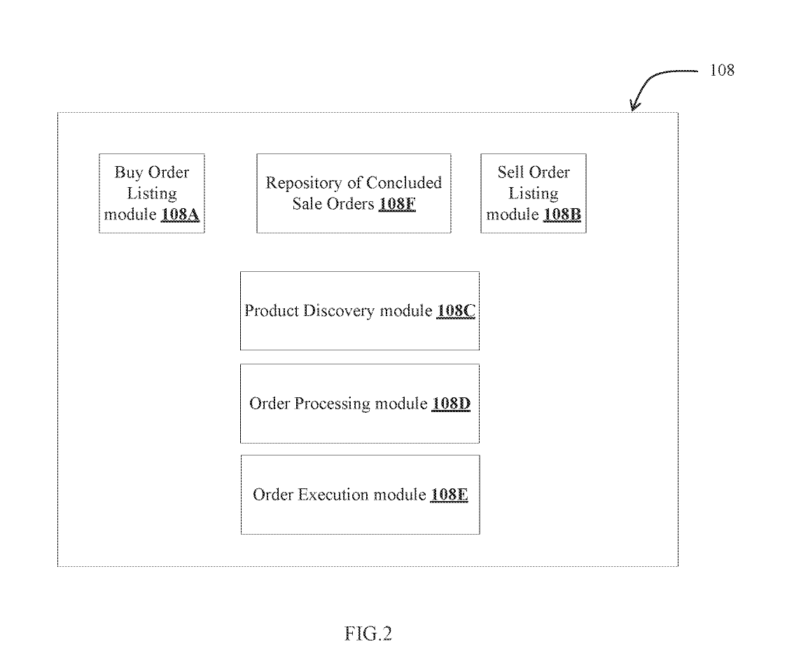

FIG. 1 illustrates an exemplary block diagram of a system for resolving data conflicts in order management of data products, in accordance with an embodiment of the present disclosure and FIG. 2 is an exemplary representation of functional modules comprising the system 100, in accordance with an embodiment of the present disclosure.

In an embodiment, the system 100 includes one or more processors 102, communication interface device(s) or input/output (I/O) interface(s) 104, and memory 106 or one or more data storage devices comprising one or more modules 108 operatively coupled to the one or more processors 102. The one or more processors are hardware processors that can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the system 100 can be implemented in one or more computing systems, such as a laptop computer, a desktop computer, a notebook, a workstation, a mainframe computer, a server, a network server, cloud, hand-held device, wearable device and the like.

The I/O interface device(s) 104 can include a variety of software and hardware interfaces, for example, a web interface, a graphical user interface, IOT interface, and the like and can facilitate multiple communications within a wide variety of networks and protocol types, including wired networks, for example, LAN, cable, etc., and wireless networks, such as WLAN, cellular, or satellite. In an embodiment, the I/O interface device(s) 104 can include one or more ports for connecting a number of devices to one another or to another server.

The memory 106 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, various modules 108A through 108F (of FIG. 2) of the system 100 can be stored in the memory 106 as illustrated.

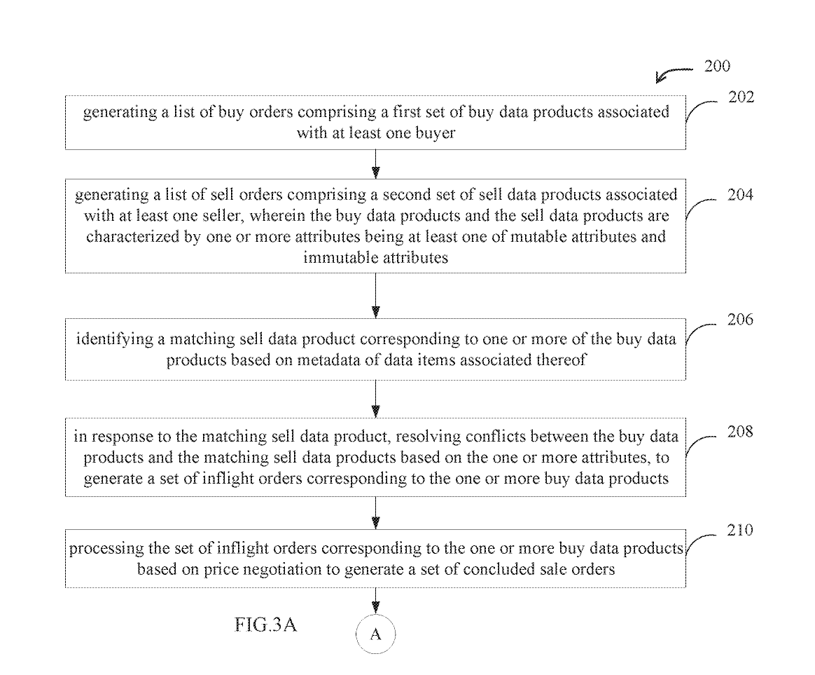

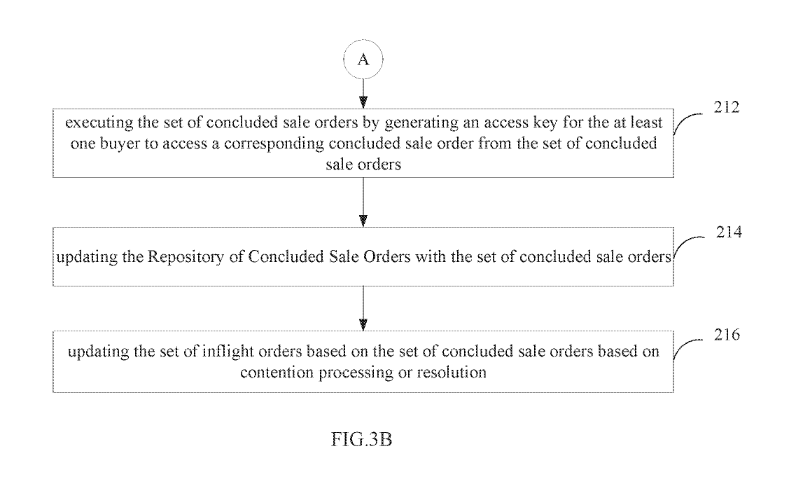

FIG. 3A and FIG. 3B illustrate a computer implemented method 200 for resolving data conflicts in order management of data products, in accordance with an embodiment of the present disclosure. The computer implemented method 200 will now be explained with reference to the components of the system 100 as depicted in FIG. 1 and FIG. 2. In an embodiment, the system 100 is configured to receive orders (Order 1, Order 2, . . . , Order n) and generate concluded sale orders (Concluded Sale Order 1, Concluded Sale Order 2, . . . , Concluded Sale Order n). In an embodiment, the orders may be one or more buy orders; one or more sell orders; or a combination thereof. In an embodiment, a Buy Order Listing Module 108A is configured to, at step 202, generate a list of buy orders including a first set of buy data products that one or more buyers may be interested to buy. Likewise, a Sell Order Listing Module 1088 is configured to, at step 204, generate a list of sell orders including a second set of sell data products that one or more sellers may be interested to sell. “Data product” referred to herein after refers to generally the buy data product and the sell data product. In an embodiment, the data product may be a single data product or a bundle of data products. For instance, a data product “dental hygiene products sales numbers and popularity” may include several data products such as “sensitive toothpaste sales numbers”, “herbal toothpaste sales numbers”, “whitening toothpaste sales numbers”, “dental floss popularity by brand, region and city”, and the like. Alternatively, a data product say “toothpaste sales numbers”, may be a single data product, digitally placed for a business deal between buyers and sellers in a voluminous data hub such as data marketplace. Data items associated with the exemplary data product “toothpaste sales numbers” may be characterized by metadata such as “region”, “brand name”, “chemical composition”, “availability”, “price”, “sales numbers”, and the like.

The data products may be characterized by one or more attributes or base characteristics on which a data product is built such as details (granularity, quality, format and so on) of the data product and suggested contract terms of the product (can it be resold, how many copies can be sold, whether it can be moved outside a geography, other exclusions, etc.). In an embodiment, the one or more attributes may include (a) non-financial attributes comprising the metadata associated with the data items, reputation scores of the associated sellers or buyers, contract terms and privacy requirements; and (b) financial attributes comprising price associated thereof. Of these attributes, some attributes such as contract terms may include some immutable (cannot be changed) terms and conditions, while others may be negotiable. Some examples of immutable contract terms may be whether it can be resold in an un-aggregated form, (especially in the case of data that has a component like personally identifiable information (PII)) or can the data be used or moved outside a certain geography or whether it is barred for selling to a specific set of individuals or parties.

An exemplary list of data products with some exemplary data items may be as represented herein below—

| Data Product | Description | Meta Data Attributes | . . . |
|---|---|---|---|
| Manufacturer X's | Toothpaste sales | Region, City, Brand | . . . |
| Toothpaste sales | numbers for | Name, Composition, | |
| numbers in India | Manufacturer X's | Availability, Price, # | |
| | brands and region | sold | |
| | in India | | |
| Manufacturer Y's | Toothpaste sales | Region, City, Brand | |
| sales numbers in | numbers for | Name, Composition, | |
| India | Manufacturer Y's | Availability, Price, # | |
| | brands and region | sold | |
| | in India | | |
| Breath Freshener | Breath Freshener | Region, | . . . |
| sales numbers in | sales numbers by | Manufacturer, Brand | |
| India | brand and region | Name, Composition, | |
| | in India | Availability, Price, # | |
| | | sold | |
| Dental Floss | Survey results at | Region, City, Brand | . . . |
| popularity in India | retail stores for | Name, Popularity as | |
| | popularity of | a percentage | |
| | dental floss | | |
| | brands in India | | |
| . . . | . . . | . . . | . . . |

In an embodiment, the system 100 of the present disclosure may include a Repository of Concluded Sale Orders 108F configured to receive one or more of (i) price associated with the data product received from a price discovery module 300 (ii) privacy requirements associated with the data product received from a data privacy module 400 (iii) reputation scores associated with the buyers and sellers of the buy orders and the sell orders respectively from a reputation and complaint module 500 (iv) terms and conditions associated with the data products received from a contract management module 600 and (v) and any other information relevant to the trade of data products from other modules 600. In an embodiment, the price discovery module 300, the data privacy module 400, the reputation and complaint module 500, the contract management module 600 and the other modules 700 may be comprised in a data marketplace platform including the system 100 of the present disclosure. Alternatively, these modules may form part of a third party system.

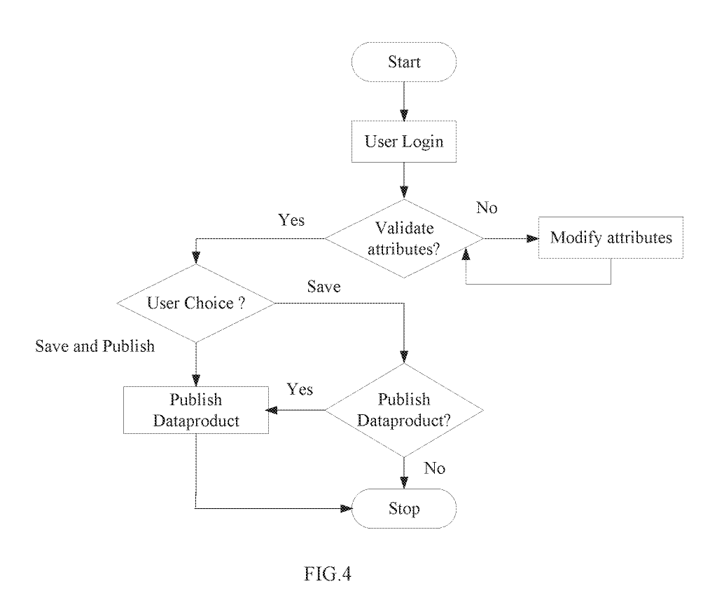

FIG. 4 illustrates a flow diagram of an exemplary process for generating a data product, being a buy data product or a sell data product in accordance with an embodiment of the present disclosure. Users (buyers or sellers) may login to the system 100 and fill in the one or more attributes associated with a data product. In an embodiment, the one or more attributes may be received in a templatized form. The details maybe validated for form and conformance with at least the immutable attributes associated with a corresponding previously concluded sale order in the Repository of Concluded Sale Orders 108F. Post validation of the attributes, the data products may be listed as part of buy orders or sell orders. In an embodiment, users may exercise a choice or option to publish the validated data products or save the validated data products to be published at a later instance of time.

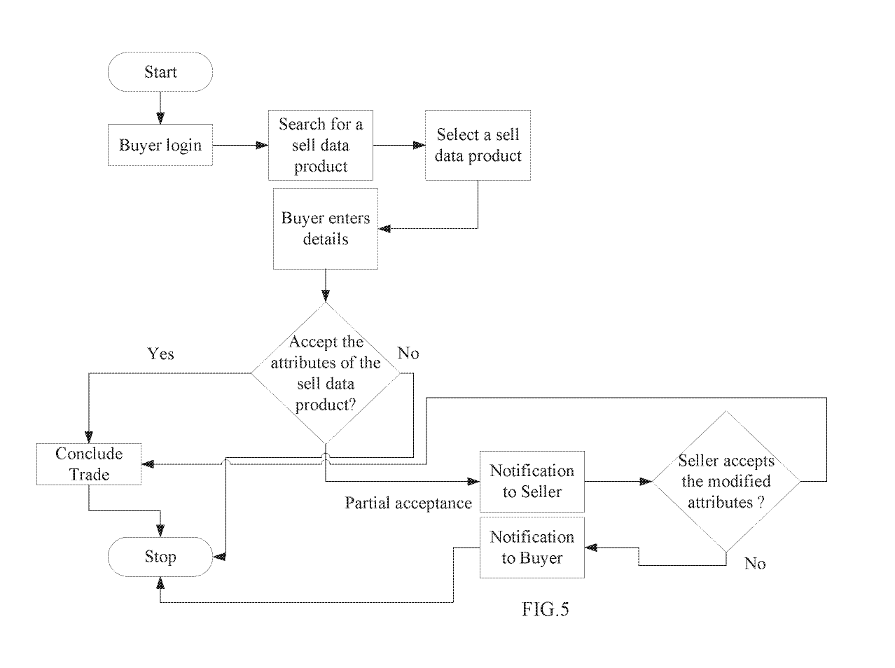

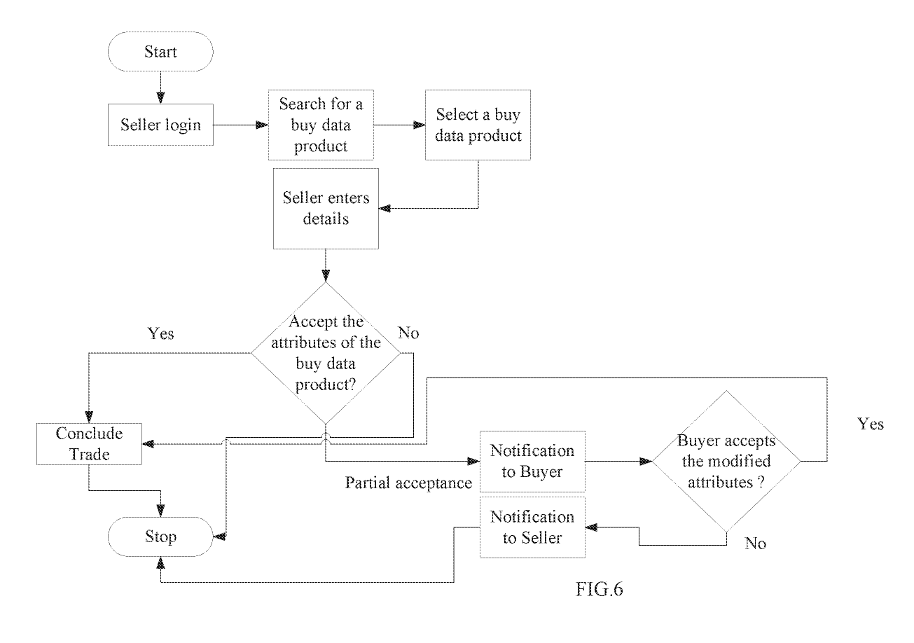

Although theoretically data products can be sold any number of times, there may be limitations governed by local laws or specific directions from sellers who own the data products or brokers who facilitate the trade on the data marketplace. In an embodiment, a Product Discovery module (108C) is configured, at step 206, to identify a matching sell data product corresponding to one or more of the buy data products based on metadata of data items comprised therein. FIG. 5 illustrates a flow diagram of an exemplary process when a buyer places an order for a sell data product in accordance with an embodiment of the present disclosure. When a buyer needs to buy a data product, he may login to the system 100 and search for a matching sell data product in the second set. Upon identifying a sell data product of interest, the buyer may modify some of the details or attributes associated with the identified or referenced sell data product. Alternatively, there may be instances where a buyer advertises intent and attributes even without a seller. In such situations sellers may emerge in response to the buy orders. Accordingly, in the absence of a match, the buyer may create a new buy data product in accordance with the process of FIG. 4 and wait for a corresponding sell data product to be generated. Likewise, FIG. 6 illustrates a flow diagram of an exemplary process when a seller places an order for a buy data product in accordance with an embodiment of the present disclosure. When a seller needs to sell a data product, he may login to the system 100 and search for a matching buy data product in the first set. Upon identifying a buy data product of interest, the seller may modify some of the details or attributes associated with the identified or referenced buy data product. Alternatively, in the absence of a match, the seller may create a new sell data product in accordance with the process of FIG. 4 and wait for a corresponding buy data product to be generated.

In an embodiment, the buy data product may not be provided by a single seller but may be created or collected by a crowd. Accordingly, in an embodiment, the system 100 may bundle a plurality of sell data products which may be referred as parent sell data products, to generate a child sell data product to match the buy order under consideration. Child sell data products may inherit at least the immutable attributes associated with the parent sell data products. The system 100 may thus have a large management overhead. The buyer may be allowed to specify different contractual biding laws and pricing depending on the amount of data that has been collected. In such special circumstances, as part of order management, the system 100 may publish an open call for data on buyer selected channels, e.g. crowd sourcing platforms. In this situation, parent-child relationship is renegotiated or negotiated multiple times.

In an embodiment, the Product Discovery module (108C) is configured to, at step 208, resolve conflicts between the buy data products and the corresponding matching sell data products based on the one or more attributes to generate a set of inflight orders corresponding to the one or more buy data products. Accordingly, the buyer may review firstly the non-financial attributes associated with the matching sell data product. The buyer may accept the non-financial attributes or propose modifications to the seller associated with the sell data product. In an embodiment, at least some of the attributes associated with at least one of the buy data product and the corresponding matching sell data product such as mutable contract terms or mutable privacy requirements, may be negotiated for modifications. In the event that the buyer accepts the non-financial attributes or the seller accepts the proposed modifications, the Product Discovery module (108C) is configured to further check conformance of agreed upon non-financial attributes with corresponding previously concluded sale orders matching the buy order. Post conformance of the non-financial attributes, the matching sell data product may be identified as an inflight order.

In an embodiment, the conformance with the non-financial attributes may be checked based on at least one of a reasoning technique or big data techniques such as Natural Language Processing (NLP), text mining using machine or deep learning techniques alluding to the specific set of domain attribute descriptors based on the specific buy order or sell order. In an embodiment, the non-financial attributes may be checked based on industry or domain specific ontology.

In an embodiment, an Order Processing module (108D) is configured to, at step 210, process the set of inflight orders corresponding to the one or more buy data products based on price negotiation to generate a set of concluded sale orders. The price negotiation may involve direct modification of price or rule based modification of price of at least one of the buy data product and the corresponding inflight order. On concluding the associated financial attributes, the set of concluded sale orders may be generated. In an embodiment, a price discovery mechanism such as direct negotiation, offer-bid matching, auction based price discovery mechanism, and the like may be implemented for concluding on the financial attributes

In an embodiment, an Order Execution module (108E) is configured to, at step 210, execute the set of concluded sale orders by generating an access key for the buyer to access a corresponding concluded sale order from the set of concluded sale orders. Firstly, upon concluding on the financial attributes, the Order Execution module (108E) may check again for conformance of the non-financial attributes associated with the set of concluded sale orders with the corresponding previously concluded sale order in the Repository of Concluded Sale Orders (108F) to ensure that at least the immutable attributes, if any, have not been violated in the process of negotiation of financial attributes. In an embodiment, secure communication is maintained between the buyers and sellers using Digital Signature Schemes (DSS). The Order Execution module (108E) then checks for confirmation of financial settlement of the set of concluded sale orders before generating the access key for granting access to the data products comprised in the concluded sale orders. In an embodiment, when concluded sale orders are generated, an escrow mechanism may be invoked to facilitate execution of the concluded sale orders.

In an embodiment, upon generating the access key which essentially marks the conclusion of trade, the Repository of Concluded Sale Orders (108F) may be updated by the set of concluded sale orders. Furthermore, contention processing or resolution (such as semaphores) may be employed to track attributes of the inflight orders to ensure that no orders contradict the terms mentioned therein. Accordingly, the set of inflight orders may also be to ensure affected inflight orders are dealt with (cancelled typically and notification provided to the seller/buyer involved).

In an embodiment, the Order Processing module 108D is configured to invoke the contract management module 600 for negotiation of contract terms and conditions. Likewise, the price discovery module 300 may be invoked for price negotiation. Finally, the reputation and complaint module 500 may be invoked to ensure that reputation scores or ranks associated with the buyers and sellers are considered before the inflight orders are generated.

More than hundred thousand (maybe in millions) of orders are required to be processed in an hour while handling the complexity of data products and the myriad possibilities of conflicts involved that need to be detected quickly enough to process in-flight transactions is a major challenge addressed by systems and methods of the present disclosure. In an embodiment, GNDM multiple queues technique or Big data tools may be implemented for processing the huge volume of orders.

Thus methods and systems of the present disclosure facilitate resolving of conflicts that may arise in a data exchange where buy or sell orders are getting executed for data products leading to high payoffs between buyers and sellers. There could be contentions between some sets of completed orders and others that are inflight of a data product (containing data items, contract terms, etc.) that is being bought or sold and some of the sets of not yet concluded orders of the product, or between completed orders and immutable aspects of the data product. The methods and systems of the present disclosure help to track the terms of inflight order and ensure that no orders contradict the terms of the data products.

An embodiment of the method of the present disclosure may be explained with reference to a set of exemplary data products. Let data products (buy data products/sell data products) available in a data marketplace be as shown herein below.

| P1 | # |
|---|---|
| Manufacturer X's | Data Product |
| Toothpaste sales numbers | |
| in India | |
| Seller | Listed By Buyer |
| | or Seller |
| Toothpaste sales numbers | Description |
| for Manufacturer X's brands | |
| and region in India | |
| Region, City, Brand Name, | Meta Data of |
| Composition, Availability, | data items |
| Price, # sold | (Non-financial |
| | attribute) |
| Mandatory: | Terms and |
| 1) Not for sale or resale to | Conditions |
| Manufacturer Y | (Non-financial |
| 2) For Sale Only in India | attribute) |
| Direct Negotiation | Price Discovery |
| | Method |
| 3 | Quantity |
| >55,000 | Price (Financial |
| | attribute) |
| . . . | . . . |

| . . . | P4 | P3 | P2 |
|---|---|---|---|
| . . . | Breath Freshener | Dental Floss popularity | Manufacturer Y's |
| | sales numbers in | in India | Toothpaste sales numbers |
| | India | | in India |
| | Buyer | Buyer | Seller |
| . . . | Breath Freshener | Survey results at retail | Toothpaste sales numbers |
| | sales numbers by | stores for popularity of | for Manufacturer Y's brands |
| | brand and region in | dental floss brands in | and region in India |
| | India | India | |
| . . . | Region, | Region, City, Brand | Region, City, Brand Name, |
| | Manufacturer, | Name, Popularity as a | Composition, Availability, |
| | Brand Name, | percentage | Price, # sold |
| | Composition, | | |
| | Availability, Price, # | | |
| . . . | Mandatory: | Negotiable: | Mandatory: |
| | 1) Buyer is | 1) Buyer is authorized to | 1) Not for sale or resale to |
| | authorized to resell | resell this product | Manufacturer X |
| | this product | | 2) For Sale Only in India |
| . . . | Direct Negotiation | Direct Negotiation | Direct Negotiation |
| . . . | 1 | 1 | 1 |
| . . . | <70,000 | <60,000 | >40,000 |
| . . . | . . . | . . . | |

Let the list of buy orders be as under.

| Buy | Order | Data | Additional/Changed Terms | |
|---|---|---|---|---|
| Order # | Placed By | Product | & Conditions | . . . |
| B1 | Buyer 1 | P3 | — | . . . |
| B2 | Buyer 2 | P4 | — | . . . |
| B3 | Buyer 3 | P1 | Additional Term: | . . . |
| | | | 1. Not for sale to Buyer 6 | |
| B4 | Buyer 4 | P2 | — | . . . |
| B5 | Buyer 5 | P2 | — | . . . |
| B6 | Buyer 6 | P1 | — | . . . |
| . . . | . . . | . . . | . . . | . . . |

It may be noted that B1 and B2 are buy orders created by the system when a buyer entered details of the buy data product for listing in the buy order list.
Let the list of sell orders be as under.

| Sell | Order | Data | Additional/Changed Terms | |
|---|---|---|---|---|
| Order # | Placed By | Product | & Conditions | . . . |
| S1 | Seller 1 | P1 | — | . . . |
| S2 | Seller 2 | P2 | — | . . . |
| S3 | Seller 3 | P4 | — | . . . |
| S4 | Seller 4 | P3 | Do not agree to negotiable | . . . |
| | | | term listed. Additional Term: | |
| | | | 1. Resale is not permitted | |
| S5 | Seller 5 | P4 | Additional Term: | . . . |
| | | | 1. Data cannot be sold | |
| | | | outside India | |
| S6 | Seller 6 | P3 | — | . . . |
| . . . | . . . | . . . | . . . | . . . |

It may be noted that S1 and S2 are sell orders created by the system when a seller entered details of the sell data product for listing in the sell order list. The matched sets of buy and sell orders based on metadata of data items:

| Buy | | Sell | | Data | |
|---|---|---|---|---|---|
| Order # | Buyer | Order # | Seller | Product | . . . |
| B1 | Buyer 1 | S4 | Seller 4 | P3 | . . . |
| B1 | Buyer 1 | S6 | Seller 6 | P3 | . . . |
| B2 | Buyer 2 | S3 | Seller 3 | P4 | . . . |
| B2 | Buyer 2 | S5 | Seller 5 | P4 | . . . |
| B3 | Buyer 3 | S1 | Seller 1 | P1 | . . . |
| B4 | Buyer 4 | S2 | Seller 2 | P2 | . . . |
| B5 | Buyer 5 | S2 | Seller 2 | P2 | . . . |
| B6 | Buyer 6 | S1 | Seller 1 | P1 | . . . |
| . . . | . . . | . . . | . . . | . . . | . . . |

Following may be noted from the matched sets of buy and sell orders:
1) Buyer 1 has a matched sell order with seller 4 and seller 6.
2) Buyer 2 has a matched sell order with seller 3 and seller 5.
3) Buyer 3 and buyer 6 have a matched sell order with seller 1.
4) Buyer 4 and buyer 5 have a matched sell order with a seller 2.
Set of inflight orders based on conformance of the non-financial attributes:

| | Referenced | | | |
|---|---|---|---|---|
| Order # | Order # | Price | Qty | . . . |
| S1 | | | 3 | . . . |
| S2 | | | 1 | . . . |
| B1 | | | 1 | . . . |
| B2 | | | 1 | . . . |
| S4 | B1 | 65,000 | 1 | . . . |
| S6 | B1 | 58,000 | 1 | . . . |
| S3 | B2 | 72,000 | 1 | . . . |
| S5 | B2 | 65,000 | 1 | . . . |
| B3 | S1 | 70,000 | 1 | . . . |
| B6 | S1 | 55,000 | 1 | . . . |
| B4 | S2 | 42,000 | 1 | . . . |
| B5 | S2 | 43,000 | 1 | . . . |
| . . . | . . . | . . . | . . . | . . . |

It may be noted that there are no referenced orders against orders S1, S2, B1, B2 since these orders in the example were created by the system and not generated in response to an intent to buy a listed buy order or in response to an intent to sell a listed sell order.
During price discovery by direct negotiation, prices for inflight orders may vary as shown below in a set of concluded sale orders for the above set of inflight orders.

| | Referenced | | |
|---|---|---|---|
| Order # | Order # | Price | . . . |
| S4 | B1 | 65,000 | . . . |
| S3 | B2 | 72,000 | . . . |
| B3 | S1 | 90,000 | . . . |
| B5 | S2 | 43,000 | . . . |
| . . . | . . . | . . . | . . . |

It may be noted that the order B3 now commands a higher price than what was quoted on account of the additional condition—not for sale to Buyer 6 that enabled seller 1 to hike the associated price during direct negotiation. Updated set of inflight orders based on the set of concluded sale orders may be as under:

| | Reference | | | |
|---|---|---|---|---|
| Order # | Order # | Price | Qty | . . . |
| S1 | | | 2 | . . . |
| . . . | . . . | . . . | . . . | . . . |

It may be noted that since buy order B3 went through, the quantity of S1 order would be updated to 2 from originally available quantity 3 and the data product P1 now has a mandatory clause added which does not allow further sale to Buyer 6.

In an embodiment, systems of the present disclosure may be a part of a data exchange platform, which administers business processes related to orders for data products and related services. Systems of the present disclosure automate and streamline order processing for businesses by providing constantly updated inventory information, a database of vendors, a database of customers, a record of customer returns and refunds, information on billing and payments, order processing records, and general ledger information. Benefits of the systems and methods of the present disclosure include improved sales visibility, improved customer relations, and efficient order processing with a minimum of delays and back-orders due to conflict resolution handled being handled in a comprehensive manner.

Systems and methods of the present disclosure may find application in but not limited to one or more of:

Telecom—To keep track of customers, accounts, credit verification, product delivery, billing, etc.;

Retail—Large retail companies use OMS to keep track of orders from customers, stock level maintenance, packaging and shipping;

Pharmaceuticals and healthcare;

Automotive—to keep track of parts sourced through original equipment manufacturers (OEMs);

Financial services;

Media and Publishing industry where there could be multiple orders for a publication (book/article/etc.); and

Logistics and Supply chain is a big area where this mechanism can be applied for tracking and managing orders.

The written description describes the subject matter herein to enable any person skilled in the art to make and use the embodiments of the invention. The scope of the subject matter embodiments defined here may include other modifications that occur to those skilled in the art. Such other modifications are intended to be within the scope if they have similar elements that do not differ from the literal language of the claims or if they include equivalent elements with insubstantial differences from the literal language.

It is, however to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the invention may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules comprising the system of the present disclosure and described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The various modules described herein may be implemented as either software and/or hardware modules and may be stored in any type of non-transitory computer readable medium or other storage device. Some non-limiting examples of non-transitory computer-readable media include CDs, DVDs, BLU-RAY, flash memory, and hard disk drives.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Further, although process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

The preceding description has been presented with reference to various embodiments. Persons having ordinary skill in the art and technology to which this application pertains will appreciate that alterations and changes in the described structures and methods of operation can be practiced without meaningfully departing from the principle, spirit and scope.

1. A processor implemented method (200) comprising:
generating, by a Buy Order Listing module (108A), a list of buy orders comprising a first set of buy data products associated with at least one buyer (202);
generating, by a Sell Order Listing module (108B), a list of sell orders comprising a second set of sell data products associated with at least one seller (204);
wherein the buy data products and the sell data products are characterized by one or more attributes being at least one of mutable attributes and immutable attributes;
identifying, by a Product Discovery module (108C), a matching sell data product corresponding to one or more of the buy data products based on metadata of data items associated thereof (206);
in response to the matching sell data product, resolving conflicts, by the Product Discovery module (108C), between the buy data products and the matching sell data products based on the one or more attributes, to generate a set of inflight orders corresponding to the one or more buy data products (208); and
processing, by an Order Processing module (108D), the set of inflight orders corresponding to the one or more buy data products based on price negotiation to generate a set of concluded sale orders (210).

2. The processor implemented method of claim 1 further comprising executing, by an Order Execution module (108E), the set of concluded sale orders by generating an access key for the at least one buyer to access a corresponding concluded sale order from the set of concluded sale orders (212).

3. The processor implemented method of claim 2, wherein the one or more attributes comprise (a) non-financial attributes comprising the metadata associated with the data items, reputation scores of the associated sellers or buyers, contract terms and privacy requirements; and (b) financial attributes comprising price associated thereof.

4. The processor implemented method of claim 3, wherein the step of generating the list of buy orders or the list of sell orders comprises:
receiving the one or more attributes associated with the buy data products or the sell data products, wherein at least some of the one or more attributes are in a templatized form;
validating the received one or more attributes for form and conformance with at least the immutable attributes associated with a corresponding previously concluded sale order; and
publishing the validated buy data products and the sell data products in the list of buy orders and the list of sell orders respectively.

5. The processor implemented method of claim 3, wherein the matching sell data product corresponding to the one or more buy data products is either one sell data product from the second set or a child sell data product created in the second set by bundling a plurality of sell data products, being parent sell data products from the second set, wherein the child sell data product inherits at least the immutable attributes associated with the parent sell data products.

6. The processor implemented method of claim 5, wherein generating the set of inflight orders corresponding to the one or more buy data products by resolving conflicts comprises one or more of:
checking conformance of the non-financial attributes associated with the matching sell data product with at least one of (a) the non-financial attributes associated with a corresponding buy data product; and (b) a corresponding previously concluded sale order matching the corresponding buy data product in a Repository of Concluded Sale Orders (108F);
selectively identifying the matching sell data product as an inflight order based on ranks associated with at least one of the corresponding buyer and seller; and
modifying at least some of the mutable attributes associated with at least one of the buy data product and the corresponding matching sell data product.

7. The processor implemented method of claim 6, wherein the step of checking conformance is based on at least one of a reasoning technique or big data techniques.

8. The processor implemented method of claim 6, wherein the step of processing the set of inflight orders corresponding to the one or more buy data products based on price negotiation comprises:
modifying price associated with at least one of the buy data product and the corresponding inflight order; and
concluding on the associated financial attributes by a price discovery mechanism to generate the set of concluded sale orders.

9. The processor implemented method of claim 8, wherein the step of executing the set of concluded sale orders comprises one or more of:
checking conformance of the non-financial attributes associated with the set of concluded sale orders with the corresponding previously concluded sale order in the Repository of Concluded Sale Orders (108F); and
generating the access key after financial settlement of the set of concluded sale orders.

10. The processor implemented method of claim 9 further comprising:
updating the Repository of Concluded Sale Orders (108F) with the set of concluded sale orders (214); and
updating the set of inflight orders based on the set of concluded sale orders based on contention processing or resolution (216).

11. A system (100) comprising:
one or more processors (102); and
one or more internal data storage devices (106) operatively coupled to the one or more processors (102) for storing instructions configured for execution by the one or more processors (102), the instructions being comprised in:
a Buy Order Listing module (108A) configured to generate a list of buy orders comprising a first set of buy data products associated with at least one buyer;
a Sell Order Listing module (108B) configured to generate a list of sell orders comprising a second set of sell data products associated with at least one seller;
a Product Discovery module (108C) configured to:
identify a matching sell data product corresponding to one or more of the buy data products based on metadata of data items associated thereof; and
in response to the matching sell data product, resolve conflicts between the buy data products and the matching sell data products based on the one or more attributes, to generate a set of inflight orders corresponding to the one or more buy data products;
an Order Processing module (108D) configured to process the set of inflight orders corresponding to the one or more buy data products based on price negotiation to generate a set of concluded sale orders; and
a Repository of Concluded Sale Orders (108F) configured to store the set of concluded sale orders.

12. The system of claim 11 further comprising an Order Execution module (108E) configured to execute the set of concluded sale orders by generating an access key for the at least one buyer to access a corresponding concluded sale order from the set of concluded sale orders.

13. The system of claim 12, wherein the one or more attributes comprise (a) non-financial attributes comprising the metadata associated with the data items, reputation scores of the associated sellers or buyers, contract terms and privacy requirements; and (b) financial attributes comprising price associated thereof.

14. The system of claim 13, wherein the Buy Order Listing module (108A) and the Sell Order Listing module (108B) are further configured to generate the list of buy orders and the list of sell order respectively by:
receiving the one or more attributes associated with the buy data products or the sell data products, wherein at least some of the one or more attributes are in a templatized form;
validating the received one or more attributes for form and conformance with at least the immutable attributes associated with a corresponding previously concluded sale order; and
publishing the validated buy data products and the sell data products in the list of buy orders and the list of sell orders respectively.

15. The system of claim 13, wherein the matching sell data product corresponding to the one or more buy data products is either one sell data product from the second set or a child sell data product created in the second set by bundling a plurality of sell data products, being parent sell data products from the second set, wherein the child sell data product inherits at least the immutable attributes associated with the parent sell data products.

16. The system of claim 15, wherein the Product Discovery module (108C) is further configured to resolving conflicts by:
checking conformance of the non-financial attributes associated with the matching sell data product with at least one of (a) the non-financial attributes associated with a corresponding buy data product; and (b) a corresponding previously concluded sale order matching the corresponding buy data product in the Repository of Concluded Sale Orders (108F);
selectively identifying the matching sell data product as an inflight order based on ranks associated with at least one of the corresponding buyer and seller; and
modifying at least some of the mutable attributes associated with at least one of the buy data product and the corresponding matching sell data product.

17. The system of claim 16, wherein the Order Processing module (108D) is further configured to process the set of inflight orders by:
modifying price associated with at least one of the buy data product and the corresponding inflight order; and
concluding on the associated financial attributes by a price discovery mechanism to generate the set of concluded sale orders.

18. The system of claim 17, wherein the Order Execution module (108E) is further configured to:
check conformance of the non-financial attributes associated with the set of concluded sale orders with the corresponding previously concluded sale order in the Repository of Concluded Sale Orders (108F);
generate the access key after financial settlement of the set of concluded sale orders;
update the Repository of Concluded Sale Orders (108F) with the set of concluded sale orders; and
update the set of inflight orders based on the set of concluded sale orders based on contention processing or resolution.

19. A computer program product comprising a non-transitory computer readable medium having a computer readable program embodied therein, wherein the computer readable program, when executed on a computing device, causes the computing device to:
generate a list of buy orders comprising a first set of buy data products associated with at least one buyer;
generate a list of sell orders comprising a second set of sell data products associated with at least one seller;
wherein the buy data products and the sell data products are characterized by one or more attributes being at least one of mutable attributes and immutable attributes;
identify a matching sell data product corresponding to one or more of the buy data products based on metadata of data items associated thereof;
in response to the matching sell data product, resolve conflicts between the buy data products and the matching sell data products based on the one or more attributes, to generate a set of inflight orders corresponding to the one or more buy data products; and
process the set of inflight orders corresponding to the one or more buy data products based on price negotiation to generate a set of concluded sale orders.

20. The computer program product of claim 19, wherein the computer readable program further causes the computing device to perform one or more of:
execute the set of concluded sale orders by generating an access key for the at least one buyer to access a corresponding concluded sale order from the set of concluded sale orders;
update a Repository of Concluded Sale Orders with the set of concluded sale orders; and
update the set of inflight orders based on the set of concluded sale orders based on contention processing or resolution.
